(19) United States
(12) Patent Application Publication
(10) Pub. No.: US 2022/0002044 A1
(43) Pub. Date: Jan. 6, 2022

(54) SOUND-GENERABLE LID, SOUND-GENERABLE BOTTLE AND METHOD

(71) Applicant: Bencoo, Inc. DBA ZippyPaws, Chino, CA (US)

(72) Inventor: Jennifer Glaser, Pasadena, CA (US)

(21) Appl. No.: 16/920,995

(22) Filed: Jul. 6, 2020

(51) Int. Cl. B65D 51/24; B65D 41/04; B65D 1/02

(52) U.S. Cl. CPC B65D 51/248; B65D 1/02; B65D 41/04

(57) ABSTRACT

The present application discloses a sound-generable lid for a bottle. The sound-generable lid comprises a lid and a sound generator. The lid comprises a lid hole. The sound generator is passed through the lid hole and is capable of generating sound when air volume inside the bottle is changed. The sound generator comprises a tube, a cap and a sound maker. The cap comprises at least one cap hole and is coupled to the tube. The sound maker is disposed within the tube. The sound maker comprises atoning wedge, a reed, an o-ring and a fixer. The toning wedge is vibrated toward the toning wedge. The toning wedge is curved. The o-ring bundles the toning wedge and the reed. The fixer fixes the o-ring inside the tube. A sound-generable bottle and a method for using the above-mentioned sound-generable lid are also disclosed.

### TECHNICAL FIELD OF THE INVENTION

The present application generally relates to pet toys, and more particularly, to a sound-generable lid, a sound-generable bottle and method for using thereof.

### BACKGROUND OF THE INVENTION

Generally, an electronic device is built in the pet toy for sound-making. However, it is required for the user to replace the battery frequently. In addition, the leakage of battery may bring contamination and it is also dangerous for the pet. Furthermore, the cost is high since the electronic structure is complicated and easily to be broken.

Another kind of pet toy uses air flow to create sound. However, this kind of pet toy may not be reused if the pet bites and destroys it.

Therefore, a need remains for a sound-generable lid, a sound-generable bottle and a method to generate sound via an easier, cheaper and reusable way.

### SUMMARY OF THE INVENTION

The present application discloses a sound-generable lid, a sound-generable bottle and a method to generate sound via an easier, cheaper and reusable way.

The sound-generable lid for a bottle comprises a lid and a sound generator. The lid comprises a lid hole. The sound generator is passed through the lid hole and is capable of generating sound when air volume inside the bottle is changed.

In various exemplary embodiments, wherein the sound generator comprises a tube, a cap and a sound maker. The cap comprises at least one cap hole and is coupled to the tube. The sound maker is disposed within the tube. The sound maker comprises a toning wedge, a reed, an o-ring and a fixer.

The toning wedge is vibrated toward the toning wedge. The toning wedge is curved. The o-ring bundles the toning wedge and the reed. The fixer fixes the o-ring inside the tube.

In various exemplary embodiments, wherein the sound generator comprises a tube, a cap and a sound maker. The cap comprises at least one cap hole and coupled to the tube. The sound maker is disposed within the tube. The lid further comprises a ridge around the lid hole; and a support coupled to the ridge. A diameter of the cap is larger than a diameter of the tube. The cap is supported by the support.

In various exemplary embodiments, the cap comprises four cap holes.

The sound-generable bottle comprises a bottle and a sound-generable lid. The sound generable lid is coupled to the bottle. The sound-generable lid comprises a lid and a sound generator. The lid comprises a lid hole. The sound generator is passed through the lid hole and is capable of generating sound when air volume inside the bottle is changed.

In various exemplary embodiments, wherein the sound generator comprises a tube, a cap and a sound maker. The cap comprises at least one cap hole and is coupled to the tube. The sound maker is disposed within the tube. The sound maker comprises a toning wedge, a reed, an o-ring and a fixer.

The toning wedge is vibrated toward the toning wedge. The toning wedge is curved. The o-ring bundles the toning wedge and the reed. The fixer fixes the o-ring inside the tube.

In various exemplary embodiments, wherein the sound generator comprises a tube, a cap and a sound maker. The cap comprises at least one cap hole and coupled to the tube. The sound maker is disposed within the tube. The lid further comprises a ridge around the lid hole; and a support coupled to the ridge. A diameter of the cap is larger than a diameter of the tube. The cap is supported by the support.

The method for using the above-mentioned sound generable lid is also disclosed. The method comprises coupling the sound-generable lid to the bottle; and changing the air volume inside the bottle by pressing and releasing the bottle.

Based on the above, the present application allows the pets to generate sound simply by pressing and releasing the bottle, reducing the trouble of utilizing the battery. In addition, the weight and the cost may also be decreased significantly since the electronic device is not required according to the present application.

In addition, current bottle lids do not offer a sound-generating function to use in pet toys. The main purpose of current bottle lid is to create an airtight seal to contain the contents of the bottle. It does not allow air to flow freely. However, the purpose of the sound-generable lid of the present application is not only for sealing the bottle, but to create cap with a lid with reed to allow air through the bottle and thus creating sound. As such, the non-reusable problem may be solved since the bottle may be changed to any kind of bottle as long as the sound-generable lid could be coupled thereto.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 shows a sound-generable lid of the present application.

FIGS. 2-3 shows explosive views of the sound-generable lid of the present application.

FIG. 4 is a cross-sectional view of the sound-generable lid of the present application.

FIG. 5 shows a sound-generable bottle of the present application.

FIG. 6 shows another sound-generable bottle of the present application.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

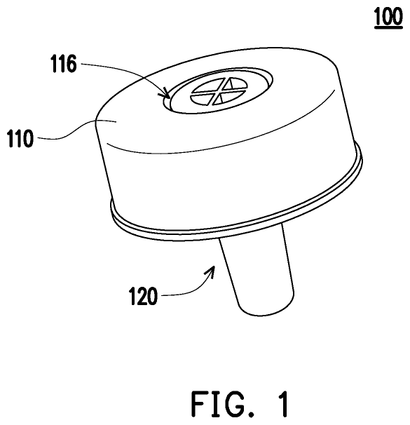

FIG. 1 shows a sound-generable lid 100 of the present application.

Referring to FIG. 1, the sound-generable lid 100 of the present application comprises a lid 110 and a sound generator 120. The lid 110 comprises a lid hole 116. The sound generator 120 is passed through the lid hole 116.

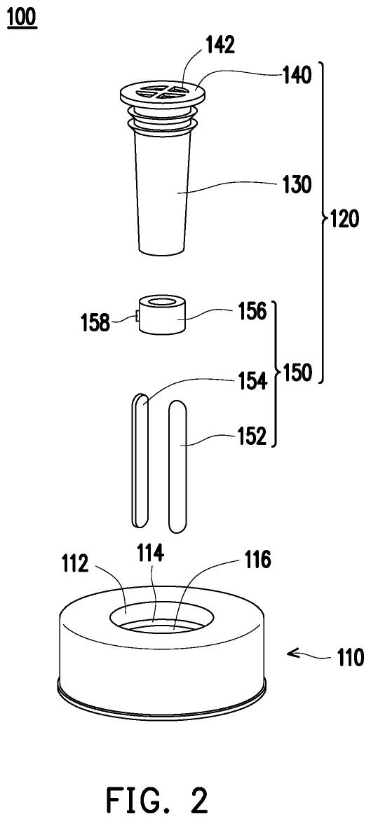

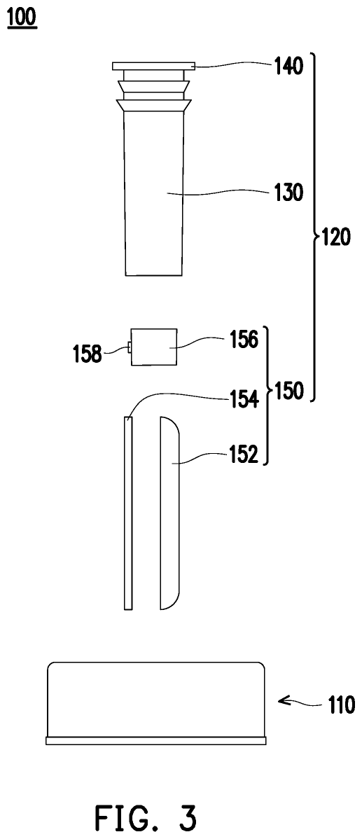

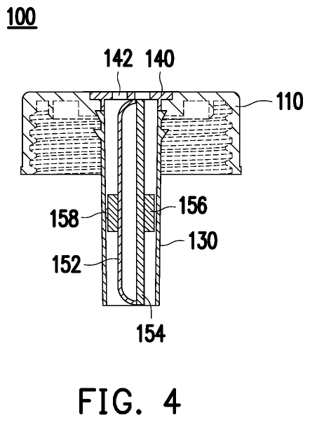

FIGS. 2-3 shows explosive views of the sound-generable lid 100 of the present application. FIG. 4 is a cross-sectional view of the sound-generable lid 100 of the present application.

Referring to FIGS. 2-4, the lid 100 further comprises a ridge 112 and a support 114. The ridge 112 is surrounded around the lid hole 116. The support 114 is coupled to the ridge 112 to form a platform for locating a cap 140. A depth of the ridge 112 and a width of the support 114 are not limited as long as the sound generator 120 could be passed through.

The sound generator 120 comprises a tube 130, a cap 140 and a sound maker 150.

The sound generator 120 is coupled to the lid 110 by passing through the tube 130 to the lid hole 116.

The cap 140 comprises at least one cap hole 142. More specifically, the cap 140 comprises four cap holes 140 as an example but not limited. The cap 140 is coupled to the tube 130 and supported by the support 114. In the present application, the cap 140 and the tube 130 could be molded integrally or separately, the present application is not limited therein.

The sound maker 150 is disposed within the tube 140. The sound maker 150 comprises a toning wedge 152, a reed 154, an o-ring 156 and a fixer 158.

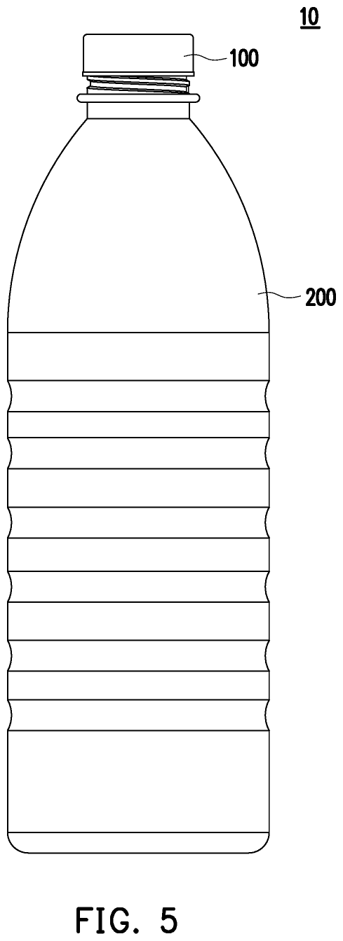

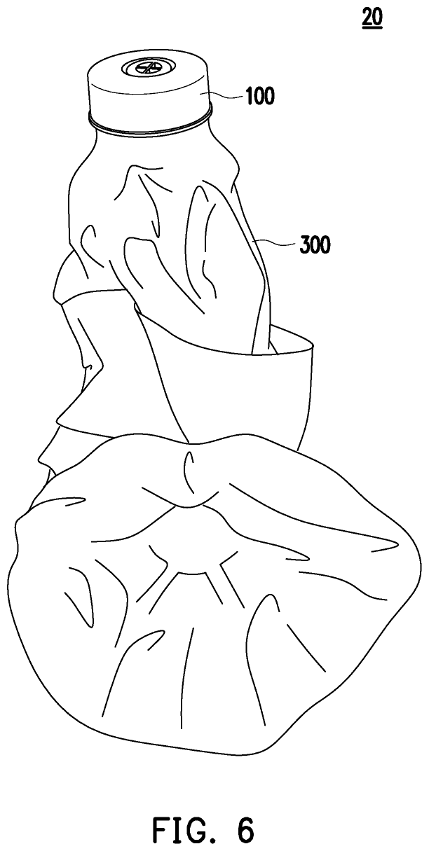

The toning wedge 152 is curved. The reed 154 is vibrated toward the toning wedge 152 when air volume inside a bottle 200/300 (referring to FIGS. 5-6) is changed. As such, the sound may be generated.

The o-ring 156 bundles the toning wedge 152 and the reed 154. In detail, the o-ring 156 bundles the central portion of the toning wedge 152 and the reed 154. As such, both ends of the reed 154 are vibrated toward the toning wedge 152 while the central portion of the reed 154 is fixed in a specific location. Therefore, the flapping of the both ends of the reed 154 and the toning wedge 152 generates the sound when the air volume inside the bottle 200/300 (referring to FIGS. 5-6) is changed.

The fixer 158 fixes the o-ring 156 inside the tube 130. Specifically, the fixer 158 is fixed inside the tube 130 and between an internal surface of the tube 130 and the o-ring 156. As such, the toning wedge 152 and the reed 154 could be fixed inside the tube without dropping down. The present application is not limited in the structure and the amount of the fixer 158. For example, the sound maker 150 may comprise more than one fixer 158. In addition, the fixer 158 may also be a ridge structure surrounded around the o-ring 156.

FIG. 5 shows a sound-generable bottle 10 of the present application. FIG. 6 shows another sound-generable bottle 20 of the present application.

Referring to FIG. 5, the sound-generable bottle 10 comprises the sound-generable lid 100 as previously described and the bottle 200. Referring to FIG. 6, the sound-generable bottle 20 comprises the sound-generable lid 100 as previously described and the bottle 300. As shown in FIGS. 5-6, it means that the sound-generable lid 100 of the present application could be coupled with different bottle. As such, if the pet destroys the bottle, the sound-generable lid 100 may be coupled to the other bottle. Therefore, the problem of high damage rate of the pet toy may be solved by reusing the sound-generable lid 100.

Based on the above, the present application allows the pets to generate sound simply by pressing and releasing the bottle, reducing the trouble of utilizing the battery. In addition, the weight and the cost may also be decreased significantly since the electronic device is not required according to the present application.

In addition, current bottle lids do not offer a sound-generating function to use in pet toys. The main purpose of current bottle lid is to create an airtight seal to contain the contents of the bottle. It does not allow air to flow freely. However, the purpose of the sound-generable lid of the present application is not only for sealing the bottle, but to create cap with a lid with reed to allow air through the bottle and thus creating sound. As such, the non-reusable problem may be solved since the bottle may be changed to any kind of bottle as long as the sound-generable lid could be coupled thereto.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A sound-generable lid for a bottle, comprising:
a lid comprising a lid hole; and
a sound generator passed through the lid hole, wherein the sound generator is capable of generating sound when air volume inside the bottle is changed.

2. The sound-generable lid for the bottle as claimed in claim 1, wherein the sound generator comprises:
a tube;
a cap comprising at least one cap hole and coupled to the tube; and
a sound maker disposed within the tube.

3. The sound-generable lid for the bottle as claimed in claim 2, wherein the sound maker comprises a toning wedge and a reed vibrated toward the toning wedge.

4. The sound-generable lid for the bottle as claimed in claim 3, wherein the sound maker further comprises an o-ring bundling the toning wedge and the reed.

5. The sound-generable lid for the bottle as claimed in claim 4, wherein the sound maker further comprises a fixer fixing the o-ring inside the tube.

6. The sound-generable lid for the bottle as claimed in claim 4, wherein the toning wedge is curved.

7. The sound-generable lid for the bottle as claimed in claim 2, wherein the lid further comprises:
a ridge around the lid hole; and
a support coupled to the ridge.

8. The sound-generable lid for the bottle as claimed in claim 7, wherein a diameter of the cap is larger than a diameter of the tube.

9. The sound-generable lid for the bottle as claimed in claim 8, wherein the cap is supported by the support.

10. The sound-generable lid for the bottle as claimed in claim 2, wherein the cap comprises four cap holes.

11. A sound-generable bottle, comprising:
a bottle;
a sound-generable lid coupled to the bottle and comprising:
a lid comprising a lid hole; and
a sound generator passed through the lid hole, wherein the sound generator is capable of generating sound when air volume inside the bottle is changed.

12. The sound-generable bottle as claimed in claim 11, wherein the sound generator comprises:
a tube;
a cap comprising at least one cap hole and coupled to the tube; and
a sound maker disposed within the tube.

13. The sound-generable bottle as claimed in claim 12, wherein the sound maker comprises a toning wedge and a reed vibrated toward the toning wedge.

14. The sound-generable bottle as claimed in claim 13, wherein the sound maker further comprises an o-ring bundling the toning wedge and the reed.

15. The sound-generable bottle as claimed in claim 14, wherein the sound maker further comprises a fixer fixing the o-ring inside the tube.

16. The sound-generable bottle as claimed in claim 14, wherein the toning wedge is curved.

17. The sound-generable bottle as claimed in claim 12, wherein the lid further comprises:
a ridge around the lid hole; and
a support coupled to the ridge.

18. The sound-generable bottle as claimed in claim 17, wherein a diameter of the cap is larger than a diameter of the tube.

19. The sound-generable bottle as claimed in claim 18, wherein the cap is supported by the support.

20. A method for using a sound-generable lid of claim 1, comprising:
coupling the sound-generable lid to the bottle; and
changing the air volume inside the bottle by pressing and releasing the bottle.
